(19) United States
(12) Patent Application Publication
(10) Pub. No.: US 2009/0244939 A1
(43) Pub. Date: Oct. 1, 2009

(54) Method and apparatus for resetting silicon controlled rectifiers in a hybrid bridge

(75) Inventor: Martin Fornage, Petaluma, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: ENPHASE ENERGY, INC.

(21) Appl. No.: 12/383,729

(22) Filed: Mar. 26, 2009

Related U.S. Application Data
(60) Provisional application No. 61/070,798, filed on Mar. 26, 2008.

(51) Int. Cl. H02H 7/122

(52) U.S. Cl. 363/58

(57) ABSTRACT

A method and apparatus for resetting Silicon Controlled Rectifiers (SCRs) in an H-bridge. The apparatus comprises a hybrid bridge, comprising at least one SCR and at least one switch, and an abnormal current detector, coupled to the hybrid bridge. The abnormal current detector detects an abnormal current in the hybrid bridge and drives the at least one switch to control current flow through the hybrid bridge.

### CROSS-REFERENCE TO RELATED APPLICATIONS

This application claims benefit of U.S. provisional patent application Ser. No. 61/070,798, filed Mar. 26, 2008, which is herein incorporated in its entirety by reference.

### BACKGROUND OF THE INVENTION

1. Field of the Invention

Embodiments of the present disclosure generally relate to power conversion and, more particularly, to a method and apparatus for controlling Silicon Controlled Rectifiers (SCR) in a hybrid H-bridge.

2. Description of the Related Art

A common topology for DC-AC inverters employs a DC-DC booster stage followed by an H-bridge. The H-bridge acts to create a true AC waveform at the inverter output by “unfurling” a rectified sine wave received from the DC-DC booster stage. In some instances, the AC output of the DC-AC inverter may be coupled to a commercial power grid, and the H-bridge operates at the frequency of the AC line voltage on the grid. For example, distributed generators (DGs), such as solar power systems, convert DC power generated by renewable resources to AC power that may be coupled to the grid.

Many DC-AC inverters employ Silicon Controlled Rectifiers (SCRs) as the H-bridge switching elements due to their robustness, easy drive, and low cost. However, in systems where the DC-AC inverter output is coupled to the grid, anomalies occurring in the AC line voltage may induce a commutation failure in such an H-bridge. For example, if the AC line voltage suddenly reverses polarity prior to its normal zero crossing, the active SCRs in the H-bridge may erroneously remain in a conductive state (“on”) during the next half of the AC line voltage cycle while the previously inactive SCRs are also switched on. This effectively “shorts” the H-bridge, resulting in an uncontrolled current surge through the inverter and subsequent damage to the inverter.

Therefore, there is a need for a method and apparatus for controlling Silicon Controlled Rectifiers (SCR) in an H-bridge.

### SUMMARY OF THE INVENTION

Embodiments of the present invention generally relate to a method and apparatus for resetting Silicon Controlled Rectifiers (SCRs) in an H-bridge. The apparatus comprises a hybrid bridge, comprising at least one SCR and at least one switch, and an abnormal current detector, coupled to the hybrid bridge. The abnormal current detector detects an abnormal current in the hybrid bridge and drives the at least one switch to control current flow through the hybrid bridge.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a power conversion module in accordance with one or more embodiments of the present invention;

FIG. 2 is a schematic diagram of an abnormal current detector in accordance with one or more embodiments of the present invention;

FIG. 3 is a schematic diagram of an abnormal current detector in accordance with one or more embodiments of the present invention; and

FIG. 4 is a flow diagram of a method for resetting SCRs in a hybrid bridge in accordance with one or more embodiments of the present invention.

### DETAILED DESCRIPTION

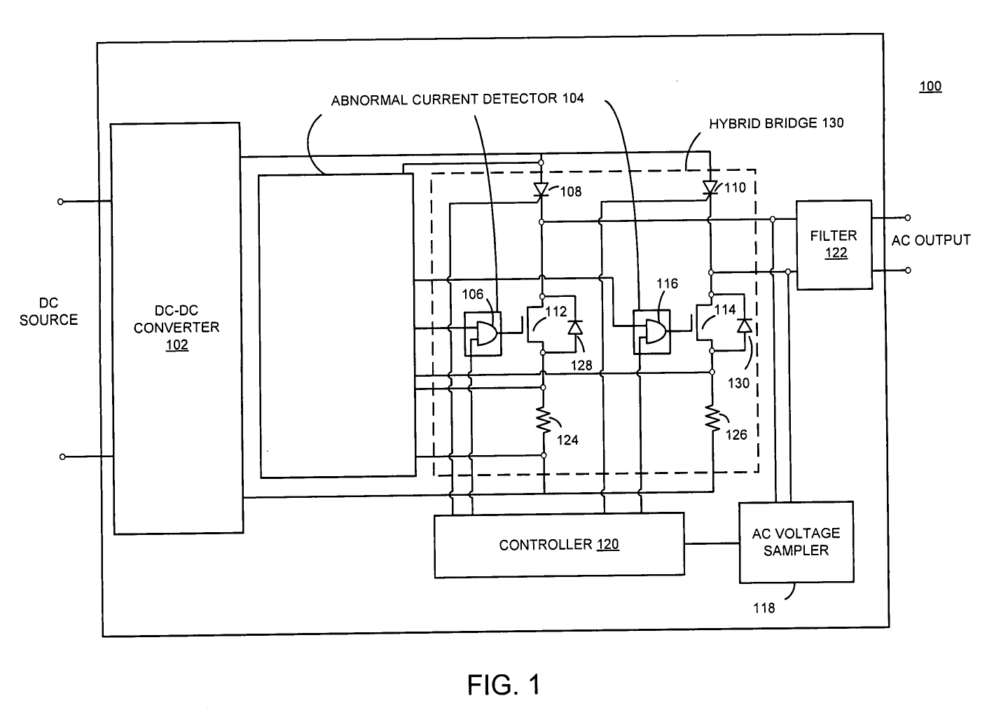

FIG. 1 is a block diagram of a power conversion module 100 in accordance with one or more embodiments of the present invention. The power conversion module 100 accepts a DC input power from a DC source and converts such DC power to an AC output power. In some embodiments, the power conversion module 100 may be employed in a DG, such as a solar power system, for converting DC power from one or more photovoltaic (PV) modules to AC power that is coupled to an AC commercial power grid.

The power conversion module 100 comprises a DC-DC converter 102, an abnormal current detector 104, a hybrid H-bridge (“hybrid bridge”) 130, a controller 120, an AC voltage sampler 118, and a filter 122. In some alternative embodiments, the DC-DC converter 102 may be excluded from the power conversion module 100. In other alternative embodiments, the DC-DC converter 102 may be external to the power conversion module 100 and coupled to the power conversion module 100. In such embodiments, a single DC-DC converter 102 may be coupled to a single power conversion module 100; alternatively, multiple DC-DC converters 102 may be coupled to a single power conversion module 100.

The DC-DC converter 102 is coupled to the hybrid bridge 130 and the controller 120. The DC-DC converter 102 accepts a DC input voltage and converts the DC input voltage to a DC output voltage in accordance with DC-DC conversion control signals received from the controller 120. The DC output voltage from the DC-DC converter 102 is then coupled to the hybrid bridge 130 through the abnormal current detector 104. The hybrid bridge 130 is coupled to the controller 120 and converts the received DC voltage to an AC output voltage in accordance with DC-AC conversion control and switching signals received from the controller 120. Such AC output voltage is then coupled to the AC commercial power grid (“grid”) via the filter 122, which acts to smooth the AC output voltage.

The hybrid bridge 130 comprises Silicon Controlled Rectifiers (SCRs) 108 and 110, switches 112 and 114, and resistors 124 and 126. In some embodiments, diodes 128 and 130 are coupled across the switches 112 and 114, respectively, with anode terminals of the diodes 128 and 130 coupled to source terminals of the corresponding switches 112 and 114. Alternatively, the diodes 128 and 130 may be an integral component of the switches 112 and 114. The switches 112 and 114 may be n-channel depletion-mode metal-oxide-semiconductor field-effect transistors (MOSFETs); alternatively, switches such as junction gate field-effect transistors (JFETs), insulated-gate bipolar transistor (IGBTs), and the like, may be used.

The SCR 108, switch 112, and resistor 124 are coupled in series such that a cathode terminal of the SCR 108 is coupled to a drain terminal of the switch 112, and a source terminal of the switch 112 is coupled to a first terminal of the resistor 124. Similarly, the SCR 110, switch 114, and resistor 126 are coupled in series such that cathode terminal of the SCR 110 is coupled to a drain terminal of the switch 114, and a source terminal of the switch 114 is coupled to a first terminal of the resistor 126. Additionally, the anode terminals of the SCRs 108 and 110 are coupled to a first output terminal of the DC-DC converter 102 and second terminals of the resistors 124 and 126 are coupled to a second output terminal of the DC-DC converter 102. Cathode terminals of the SCRs 108 and 110 are coupled to the filter 122 and to the AC voltage sampler 118.

The abnormal current detector 104 comprises AND gates 106 and 116 and provides a first input to each AND gate 106 and 116; the controller 120 is coupled to a second input of each AND gate 106 and 116. Output terminals of the AND gates 106 and 116 are coupled to gate terminals of the switches 112 and 114, respectively, for controlling (i.e., activating and deactivating) such switches. Additionally, the controller 120 is coupled to a control gate of each SCR 108 and 110 for activating (i.e., switching on) the SCRs 108 and 110, and the abnormal current detector 104 is coupled to the source terminals of the switches 112 and 114, the anode terminal of the SCR 108, and the second terminal of the resistor 124.

The controller 120 is coupled to the AC voltage sampler 118 for obtaining AC line voltage samples from the grid; additionally, the controller 120 obtains DC current and voltage samples from the DC-DC controller 102. The controller 120 utilizes such samples to produce the control and switching signals for driving the DC-DC converter 102 and the hybrid bridge 130 to generate an AC power output that is optimally achieved from the DC power input to the power conversion module 100; i.e., the AC power output from the power conversion module 100 is synchronously coupled to the grid.

In one embodiment of the present invention, the DC voltage at the output of the DC-DC converter 102 has the form of a full-wave rectified sine wave, where the frequency of the rectified sine wave is twice the frequency of the AC line voltage on the grid. Under normal operating conditions (i.e., no commutation failures or anomalies in the AC line voltage), the abnormal current detector 104 generates an active-high signal as the first inputs to the AND gates 106 and 116. Such an active-high input allows the second AND gate input signals from the controller 120 to determine the output of the AND gates 106 and 116 and thereby control the operation (i.e., activation and de-activation) of the switches 112 and 114. The controller 120 sequentially activates the hybrid bridge diagonals (i.e., SCR 108/switch 114 and SCR 110/switch 112) at AC line voltage zero-crossings in a mutually exclusive fashion such that each diagonal conducts current for half of the AC line voltage cycle. For example, the diagonal SCR 108/switch 114 conducts during a first half of the AC line voltage cycle while the diagonal SCR110/switch 112 remains off and does not conduct.

When the diagonal SCR 108/switch 114 is conducting, the current through the diagonal drops to zero at the next AC line voltage zero-crossing as the DC voltage across the hybrid bridge 130 drops to zero, causing the SCR 108 to deactivate. Additionally, the controller 120 generates an active-low input at the second input to the AND gate 116, causing the subtending switch 114 to deactivate, and activates the previously inactive diagonal SCR110/switch 112. During the subsequent half of the AC line voltage cycle, the SCR 108 remains reverse-biased (i.e., off) and the controller 120 continues to generate an active-low input to the AND gate 116 to keep the switch 114 off.

At the next AC line zero-crossing, the diagonal SCR110/switch 112 becomes inactive, while the diagonal SCR 108/switch 114 again becomes active. Such operation “unfurls” the full-wave rectified sine wave input to the hybrid bridge 130 to generate a true AC waveform at the output of the hybrid bridge 130 that is in phase with the line voltage on the grid.

In accordance with one or more embodiments of the present invention, the abnormal current detector 104 acts to detect an abnormal current in the hybrid bridge 130, such as a negative current or an excessive positive current, and accordingly drives the switches 112 and 114 to control the flow of current through the hybrid bridge 130. Such an abnormal current may be caused by a commutation failure or an abnormality in the AC waveform on the grid and may be capable of causing one of the SCRs to operate improperly. Upon detecting the abnormal current, the abnormal current detector 104 generates an active-low input to the AND gates 106 and 116, thereby driving the switches 112 and 114 to deactivate (i.e., switch off) and interrupting current flow through the hybrid bridge 130. Such current interruption immediately resets the SCRs 108 and 110 and averts any damage to the power conversion module 100. The abnormal current detector 104 further sustains the active-low input to the logic gates 106 and 116, and thus the current interruption, for a time period (i.e., a stabilization period) sufficient to allow the anomaly causing the abnormal current to clear before operation of the hybrid bridge 130 resumes.

After the stabilization period, the abnormal current detector 104 again generates an active-high input to the AND gates 106 and 116, allowing the controller 120 to once again determine the operating state of the switches 112 and 114. Normal operation of the power conversion module 100 resumes at the next zero-crossing of the AC line voltage, at which point the controller 120 will activate the appropriate diagonal pair (i.e., SCR 108/switch 114 or SCR 110/switch 112).

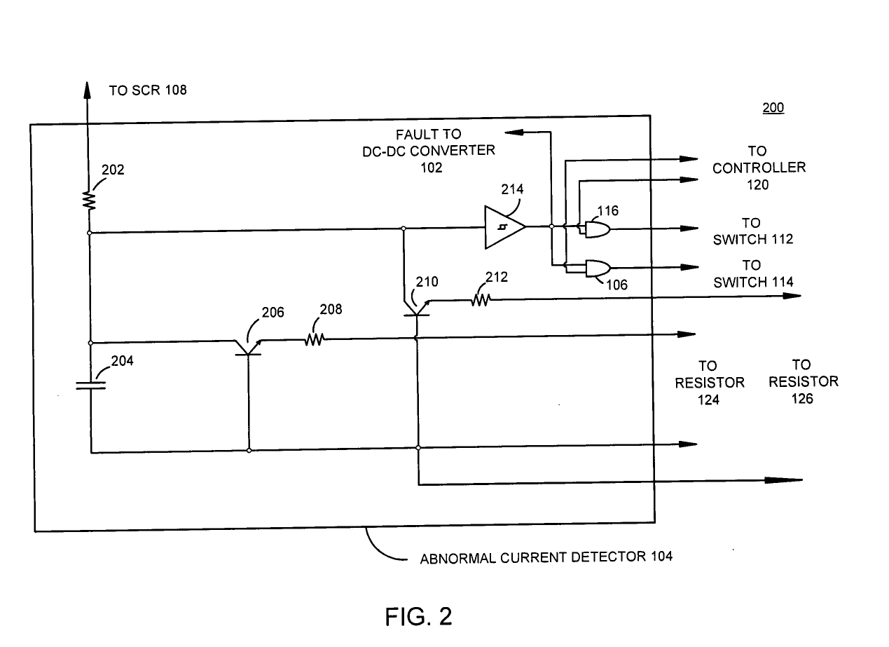

FIG. 2 is a schematic diagram of an abnormal current detector 104 in accordance with one or more embodiments of the present invention.

The abnormal current detector 104 comprises resistors 202, 208, and 212, capacitor 204, transistors 206 and 210, and a Schmitt trigger 214. In some embodiments, the transistors 206 and 210 are npn Bipolar Junction Transistors (BJTs); alternatively, other types of transistors or comparators may be utilized. Collector terminals of the transistors 206 and 210 are coupled to an input of the Schmitt trigger 214, a first terminal of the resistor 202, and a first terminal of the capacitor 204. A second terminal of the resistor 202 is coupled to the anode terminal of the SCR 108, and a second terminal of the capacitor 204 is coupled to base terminals of the transistors 206 and 210, and the second terminals of the resistors 124 and 126. Emitter terminals of the transistors 206 and 210 are coupled to first terminals of the resistors 208 and 212, respectively, and second terminals of the resistors 208 and 212 are coupled to the first terminals of the resistors 124 and 126, respectively. Additionally, an output from the Schmitt trigger 214 is coupled to the first input of each AND gate 106 and 116. During normal operation, the transistors 206 and 210 are in an off state and the capacitor 204 maintains an active-high input to the Schmitt trigger 214, resulting in an active-high output from the Schmitt trigger 214 to the AND gates 106 and 116.

During operation of the hybrid bridge 130, for example during a portion of the AC line voltage cycle when the diagonal SCR 110/switch 112 is conducting (“on”) and the diagonal SCR 108/switch 114 is not conducting (“off”), a commutation failure or anomaly on the AC line voltage may cause a negative current through the resistor 126 and the switch 114. The negative current results in a sufficient base voltage at the transistor 210 to cause the transistor 210 to activate (i.e., switch on), thereby discharging the capacitor 204. The resulting voltage drop at the input to the Schmitt trigger 214 generates an active-low input to the AND gates 106 and 116, thereby switching off the switches 112 and 114, interrupting current flow through the hybrid bridge 130, and causing the SCR 110 to stop conducting and reset.

Upon cessation of the current flow through the hybrid bridge 130, the transistor 210 switches off, allowing the capacitor 204 to slowly recharge through the resistor 202 as determined by an RC time constant of the resistor 202/capacitor 204 (i.e., a stabilization period). Such a stabilization period allows the fault to positively clear before providing sufficient voltage at the Schmitt trigger 214 to generate active-high signals to the AND gates 106 and 116 and allow the controller 120 to once again control the operation of the switches 112 and 114. In some embodiments, the resistor 202 and the capacitor 204 are selected to have an RC time constant on the order of 50 microseconds (e.g., a typical duration of a grid anomaly).

Normal operation of the hybrid bridge 130 resumes at the next zero-crossing of the AC line voltage, at which point the controller 120 activates the appropriate diagonal pair (i.e., SCR 108/switch 114 or SCR 110/switch 112).

During portions of the AC line voltage cycle where the diagonal SCR 110/switch 112 is off and the diagonal SCR 108/switch 114 is on, a negative current through the resistor 124 and the switch 112 causes the transistor 206 to switch on, interrupting current flow through the hybrid bridge 130 for a stabilization period and allowing the SCR 108 to reset analogous to the operation previously described.

In some embodiments, the output of the Schmitt trigger 214 is further coupled to the DC-DC converter 102, and an active-low output from the Schmitt trigger 214 (i.e., a “FAULT” output) causes DC-DC power production in the DC-DC converter 102 to cease, as well as the switches 112 and 114 to switch off, for the duration of the stabilization period. Following the stabilization period, the DC-DC power production in the DC-DC converter 102 is allowed to resume in addition to the normal operation of the switches 112 and 114.

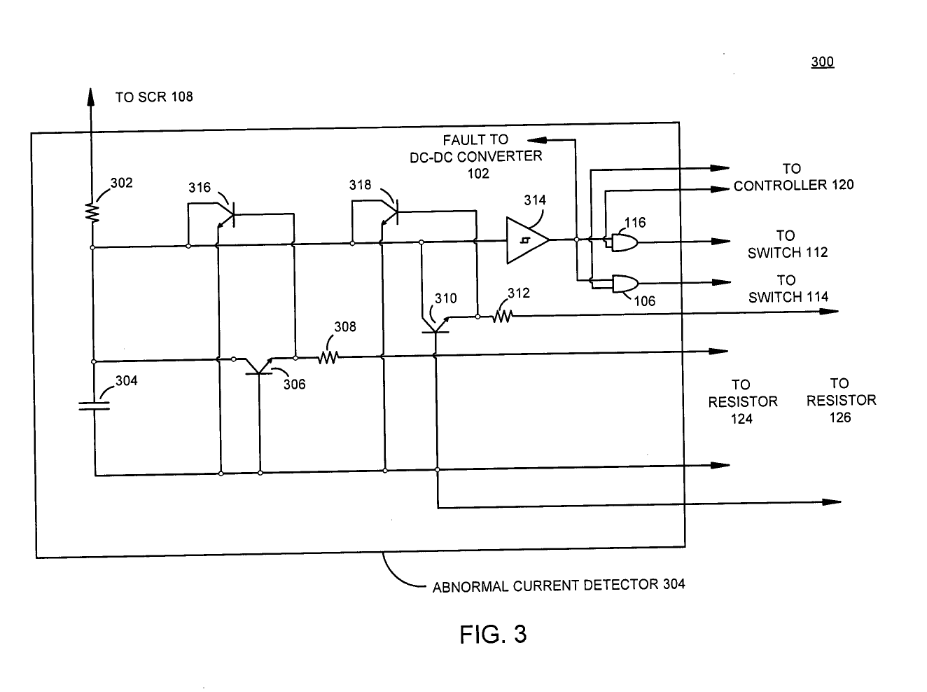

FIG. 3 is a schematic diagram of an abnormal current detector 304 in accordance with one or more embodiments of the present invention. The abnormal current detector 304 comprises resistors 302, 308, 312, capacitor 304, transistors 306, 310, 316, and 318, and a Schmitt trigger 314. In some embodiments, the transistors 306 and 310 are npn Bipolar Junction Transistors (BJTs); alternatively, other types of transistors or comparators may be utilized.

Collector terminals of the transistors 306, 310, 316, and 318 are coupled to an input of the Schmitt trigger 314, a first terminal of the resistor 302, and a first terminal of the capacitor 304. A second terminal of the resistor 302 is coupled to the anode terminal of the SCR 108, and a second terminal of the capacitor 304 is coupled to emitter terminals of the transistors 316 and 318, base terminals of the transistors 306 and 310, the second terminal of the resistor 124, and the second terminal of the resistor 126. An emitter terminal of the transistor 306 is coupled to a base terminal of the transistor 316 and a first terminal of the resistor 308; a second terminal of the resistor 308 is coupled to the first terminal of the resistor 124. An emitter terminal of the transistor 310 is coupled to a base terminal of the transistor 318 and a first terminal of the resistor 312; a second terminal of the resistor 312 is coupled to the first terminal of the resistor 126. Additionally, an output from the Schmitt trigger 314 is coupled to the first input of each AND gate 106 and 116, and the second input of each AND gate 106 and 116 is coupled to the controller 120. During normal operation, the transistors 306, 310, 316, and 318 are in an off state and the capacitor 304 maintains an active-high input to the Schmitt trigger 314, resulting in an active-high output from the Schmitt trigger 314 to the AND gates 106 and 116 that allows the second AND gate inputs from the controller 120 to determine the operation of the switches 112 and 114.

Analogous to the operation of the abnormal current detector 104, the resistors 302, 308, 312, capacitor 304, transistors 306, 310, and Schmitt trigger 314 of the abnormal current detector 304 function to detect a negative current in the hybrid bridge 130 and, when such a current is detected, interrupt current flow through the hybrid bridge 130 for a stabilization period. Additionally, the transistors 316 and 318 function to detect an excessive positive current flow through the hybrid bridge 130 and, when such a current is detected, to interrupt current flow through the hybrid bridge 130 for a stabilization period as described below.

During operation of the hybrid bridge 130, for example during a portion of the AC line voltage cycle when the diagonal SCR 110/switch 112 is conducting (“on”) and the diagonal SCR 108/switch 114 is not conducting (“off”), a fault condition may cause excessive current through the switch 112. The excessive current results in a sufficient base voltage at the transistor 316 to cause the transistor 316 to activate (i.e., switch on), thereby discharging the capacitor 304. The resulting voltage drop at the input to the Schmitt trigger 314 generates an active-low input to the AND gates 106 and 116, thereby switching off the switches 112 and 114 and interrupting current flow through the hybrid bridge 130, causing the SCR 110 to stop conducting and reset.

Upon cessation of the current flow through the hybrid bridge 130, the transistor 316 switches off, allowing the capacitor 304 to slowly recharge through the resistor 302 as determined by an RC time constant of the resistor 302/capacitor 304 (i.e., a stabilization period). Such a stabilization period allows the fault to positively clear before providing sufficient voltage at the Schmitt trigger 314 to generate an active-high signal to the AND gates 106/116 and allow the controller 120 to once again control the operation of the switches 112 and 114. In some embodiments, the resistor 302 and the capacitor 304 are selected to have an RC time constant on the order of 50 microseconds (e.g., a typical duration of a grid anomaly).

Normal operation of the hybrid bridge 130 resumes at the next zero-crossing of the AC line voltage, at which point the controller 120 activates the appropriate diagonal pair (i.e., SCR 108/switch 114 or SCR 110/switch 112).

During portions of the AC line voltage cycle where the diagonal SCR 110/switch 112 is off and the diagonal SCR 108/switch 114 is on, excessive current through the switch 114 causes the transistor 318 to switch on, interrupting current flow through the hybrid bridge 130 for a stabilization period and allowing the SCR 108 to reset analogous to the operation previously described.

In some embodiments, the output of the Schmitt trigger 314 is further coupled to the DC-DC converter 102, and an active-low output from the Schmitt trigger 314 (i.e., a “FAULT” output) causes DC-DC power production in the DC-DC converter 102 to cease, as well as the switches 112 and 114 to switch off, for the duration of the stabilization period. Following the stabilization period, the DC-DC power production in the DC-DC converter 102 is allowed to resume in addition to the normal operation of the switches 112 and 114.

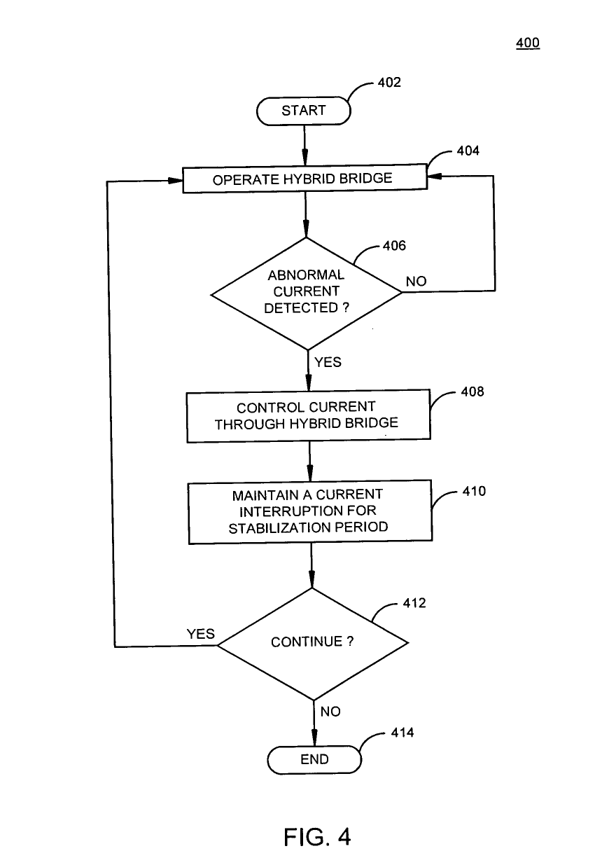

FIG. 4 is a flow diagram of a method 400 for resetting SCRs in a hybrid bridge in accordance with one or more embodiments of the present invention. In some embodiments, such as the embodiment described below, a hybrid H-bridge (“hybrid bridge”) is utilized to convert a DC input voltage to an AC output voltage, where the AC output voltage is coupled to an AC line. Each leg of the hybrid bridge consists of an SCR coupled in series to a switch, such as a MOSFET switch. During normal operation (i.e., no fault conditions causing an abnormal current through the hybrid bridge), a controller coupled to the hybrid bridge controls the activation of each SCR and the activation/deactivation of each switch of the hybrid bridge, sequentially activating each diagonal of the hybrid bridge to generate the desired AC waveform output. Additionally, an abnormal current detector is coupled to the hybrid bridge for detecting an abnormal current in the hybrid bridge and accordingly controlling the flow of current through the hybrid bridge to reset the SCRs.

The method 400 starts at step 402 and proceeds to step 404, where the DC input voltage is applied to the hybrid bridge and the hybrid bridge converts the DC input voltage to the AC output voltage based on the control and switching signals from the controller. The control and switching signals drive the hybrid bridge such that the generated AC output voltage is synchronized with an AC line voltage of the AC line. In some embodiments, the hybrid bridge may reside within a power conversion module, such as a DC-AC inverter, and the AC output voltage may be coupled to an AC commercial power grid.

At step 406, a determination is made whether an abnormal current is detected in the hybrid bridge. The abnormal current may consist of a negative current in the hybrid bridge, or an excessive positive current in the hybrid bridge. Such an abnormal current may be generated by a commutation failure or an anomaly in the AC line voltage. If an abnormal current is not detected, the method 400 returns to step 404; if an abnormal current is detected, the method 400 proceeds to step 408.

At step 408, current flow through the hybrid bridge is controlled. In some embodiments, the current flow may be interrupted by generating a first voltage to drive the switches in an inactive (off) mode. Upon cessation of the current flow, the conducting SCR of the hybrid bridge (i.e., the SCR conducting at the time the abnormal current is detected) deactivates and resets. In some embodiments where the DC input voltage to the hybrid bridge is provided by a DC-DC converter, DC-DC power production in the DC-DC converter is halted upon detecting the abnormal current, in addition to interrupting the current flow through the hybrid bridge.

The method 400 proceeds to step 410. At step 410, the method 400 waits an appropriate amount of time to allow the fault causing the abnormal current to positively clear (i.e., a stabilization period). Such a stabilization period may be determined by an RC constant of the abnormal current detector. During the stabilization period, current flow through the hybrid bridge remains interrupted, for example by maintaining the switches in the hybrid bridge in an off state. In some embodiments, the stabilization period is on the order of 50 microseconds, e.g., a typical duration of a grid anomaly. The method 400 then proceeds to step 412.

At step 412, current flow through the hybrid bridge is allowed to resume, for example by generating a second voltage that allows the operation off the switches to be controlled by the controller as during normal operation. At step 414, a determination is made whether to continue operation of the hybrid bridge. If the result of such determination is yes, the method 400 returns to step 404. Additionally, DC-DC power production of a DC-DC converter coupled to the hybrid bridge is resumed in embodiments where such power production is halted upon detecting the abnormal current.

If, at step 414, the result of the determination is no, the method 400 proceeds to step 416, where it ends.

While the foregoing is directed to embodiments of the present invention, other and further embodiments of the invention may be devised without departing from the basic scope thereof, and the scope thereof is determined by the claims that follow.

1. Apparatus for resetting Silicon Controlled Rectifiers (SCRs) in an H-bridge, comprising:
a hybrid bridge comprising at least one SCR and at least one switch; and
an abnormal current detector, coupled to the hybrid bridge, for detecting an abnormal current in the hybrid bridge and driving the at least one switch to control current flow through the hybrid bridge.

2. The apparatus of claim 1, wherein the abnormal current is at least one of a negative current or an excessive positive current.

3. The apparatus of claim 1, wherein the abnormal current detector drives the at least one switch to interrupt the current flow upon the detecting and to allow the current flow following a stabilization period.

4. The apparatus of claim 3, wherein the abnormal current detector comprises at least one logic gate, an output of the at least one logic gate coupled to the at least one switch for driving the at least one switch to interrupt the current flow when the at least one logic gate receives a first voltage and to allow the current flow when the at least one logic gate receives a second voltage.

5. The apparatus of claim 4, wherein the abnormal current detector generates the first voltage upon the detecting and generates the second voltage following the stabilization period.

6. The apparatus of claim 3, wherein the abnormal current detector further comprises a resistor and a capacitor, wherein the stabilization period is determined by an RC time constant of the resistor and the capacitor.

7. A method for resetting Silicon Controlled Rectifiers (SCRs) in an H-bridge, comprising:
detecting an abnormal current in a hybrid bridge, the hybrid bridge comprising at least one switch and at least one SCR; and
controlling current flow through the hybrid bridge in response to the detecting.

8. The method of claim 7, wherein the abnormal current is at least one of a negative current or an excessive positive current.

9. The method of claim 7, wherein the controlling current flow comprises:
interrupting the current flow through the hybrid bridge upon the detecting;
continuing the interrupting the current flow for a stabilization period; and
allowing the current flow subsequent to the stabilization period.

10. The method of claim 9 wherein the interrupting comprises:
generating a first voltage; and
driving, by the first voltage, the at least one switch to perform the interrupting.

11. The method of claim 9, wherein the allowing comprises
generating a second voltage at the completion of the stabilization period; and
driving, by the second voltage, the at least one switch to perform the allowing.

12. The method of claim 9, further comprising determining the stabilization period by an RC time constant of a device performing the interrupting.

13. The method of claim 9, further comprising:
ceasing a DC-DC power production upon the detecting and
allowing the DC-DC power production to resume following the stabilization period, the DC-DC power production providing an input power to the hybrid bridge.

14. An inverter, comprising:
a hybrid bridge comprising at least one Silicon Controlled Rectifier (SCR) and at least one switch; and
an abnormal current detector, coupled to the hybrid bridge, for detecting an abnormal current in the hybrid bridge and driving the at least one switch in the hybrid bridge to control current flow through the hybrid bridge.

15. The inverter of claim 14, wherein the abnormal current is at least one of a negative current or an excessive positive current.

16. The inverter of claim 14, wherein the abnormal current detector drives the at least one switch to interrupt the current flow upon the detecting and to allow the current flow following a stabilization period.

17. The inverter of claim 16, wherein the abnormal current detector comprises at least one logic gate, an output of the at least one logic gate coupled to the at least one switch for causing the at least one switch to interrupt the current flow when the at least one logic gate receives a first voltage and to allow the current flow when the at least one logic gate receives a second voltage.

18. The inverter of claim 17, wherein the abnormal current detector generates the first voltage upon the detecting and generates the second voltage following the stabilization period.

19. The inverter of claim 16, wherein the abnormal current detector comprises a resistor and a capacitor, wherein the stabilization period is determined by an RC time constant of the resistor and the capacitor.

20. The inverter of claim 16, further comprising a DC-DC converter for providing an input power to the hybrid bridge, wherein the abnormal current detector causes the DC-DC converter to cease DC-DC power production upon the detecting and allows the DC-DC converter to resume the DC-DC power production following the stabilization period.
